(19) United States
(12) Patent Application Publication
(10) Pub. No.: US 2006/0106685 A1
(43) Pub. Date: May 18, 2006

(54) Generating system for automatically generating the bill of materials for electrical products

(75) Inventors: Cheng Yang Cheng, Taipei (TW); Hsu Huang Lin, Taipei (TW); Hsin Chi Lee, Taipei (TW); Feng Lian Hus, Taipei (TW)

Correspondence Address: G. LINK CO., LTD;Suite 137, 931 West 75th Street, Naperville, IL, 60565, US

(73) Assignee: First International Computer, Inc.

(21) Appl. No.: 10/988,516

(22) Filed: Nov. 16, 2004

(51) Int. Cl. A01K 5/02; G06F 17/50

(52) U.S. Cl. 705/29

(57) ABSTRACT

A generating system of automatically generating electrical type product bill of materials of the present invention comprises a stock number grouping database, a stock number ranking database, and a bill of materials automatically generating processing program. The stock number grouping database comprises at least one material group records comprising at least a product group with the same electrical specification and at least one stock number group component supplier/vendor code. The stock number ranking database comprises at least one stock number ranking record, each stock number ranking record corresponds to one of the stock number group records and is used to record an evaluating rate after evaluating with the stock number group records according to a ranking critical factor. The bill of materials automatically generating processing program is used to generate a bill of materials of the corresponding electrical circuit design according to the bill of materials outline of the input electrical circuit design diagram, stock number grouping database, stock number ranking database, and a material choosing critical factor.

### FIELD OF THE INVENTION

The present invention relates to generating a bill of materials (BOM), and more specifically, to a bill of materials (BOM) automatically generating system combining a stock number grouping mechanism and a ranking mechanism.

### BACKGROUND OF THE INVENTION

The traditional way of editing a bill of materials is a process of artificially adjusting and manually editing, etc. It easily causes adjustment of faults and editing time that is too long and thus delays the electrical products being sold. Because of mistakes in the bill of materials, this causes purchasing wrong electrical components, and severe shortcomings of electrical products are made. Further, since relative people move or quit, the correct production of the bill of materials are affected too.

In view of the above mentioned shortcomings of the prior art, the inventor of the present invention invented an automatically generating system of a bill of materials (BOM) combining a stock number grouping mechanism and ranking mechanism.

### SUMMARY OF THE INVENTION

The first object of the present invention is to provide a generating system to automatically generate a bill of materials of electrical products.

The second object of the present invention is to provide adjusting according to strategies and automatically generating a bill of materials corresponding to an electrical product.

To achieve the above mentioned objects, the present invention provides a generating system of an automatically generated bill of materials of electrical products comprising: a stock number grouping database comprising at least one stock number group record, wherein each stock number group record comprises at least a product group with the same electrical specification and at least one stock number group component supplier/vendor code; a stock number ranking database comprises at least one stock number ranking record, wherein each stock number ranking record corresponds to one of the stock number group records and it is used to record a evaluating value after evaluating with the stock number ranking records according to a ranking critical factor; a bill of materials automatically generating program is used to generate a bill of materials corresponding to an electrical circuit design diagram according to an input outline of the bill of materials of the electrical circuit design diagram, the stock number grouping database, the stock number ranking database, and a material choosing critical factor.

### BRIEF DESCRIPTION OF THE DRAWINGS

The present invention can be more fully understood by reference to the following description and accompanying drawings, in which:

FIG. 1 is a scheme diagram of the generating system of a bill of materials of automatically generating electrical products of the present invention;

FIG. 2 is a structure diagram of the stock number grouping database of the present invention;

FIG. 3 is a concrete example diagram of the stock number grouping database of the present invention;

FIG. 4 is a structure diagram of the stock number ranking database of the present invention;

FIG. 5 is a concrete example diagram of the stock number ranking database of the present invention;

FIG. 6 is a screen of the stock number ranking database performing maintenance of the present invention;

FIG. 7 is an example screen of the outline of the bill of materials of the electrical products of the computer motherboard;

FIG. 8 is a main screen of the bill of materials automatically generating processing program of the present invention;

FIG. 9 is a screen of the bill of materials automatically generated by the bill of materials automatically generating processing program of the present invention which outputs the bill of materials of main materials;

FIG. 10 shows a screen of the bill of materials automatically generated by the bill of materials automatically generating processing program of the present invention which outputs the bill of materials of substituted materials;

FIG. 11 shows a screen of the bill of materials automatically generated by the bill of materials automatically generating processing program of the present invention which integrally outputs the bill of materials of main materials and substituted materials;

FIG. 12 shows an example of components listed by the critical component list by project (CCL) of the present invention; and

FIG. 13 shows an example of components listed by a disapproved vendor list by project (DVL) of the present invention.

### DETAILED DESCRIPTION OF THE INVENTION

The main function of the generating system of automatically generating bill of materials of electrical products of the present invention is automatically generating a bill of materials (BOM) corresponding to the strategies according to the strategies such that the electrical products produced according to the bill of materials can completely meet the expected preset objects. The concrete example of the strategies herein is the “best quality guarantee”, “lowest manufacturing cost”, “unleaded process electrical products”, etc. The source of the strategies can come from the purchasing unit, marketing unit, troubleshooting unit, developing unit, executives, etc.

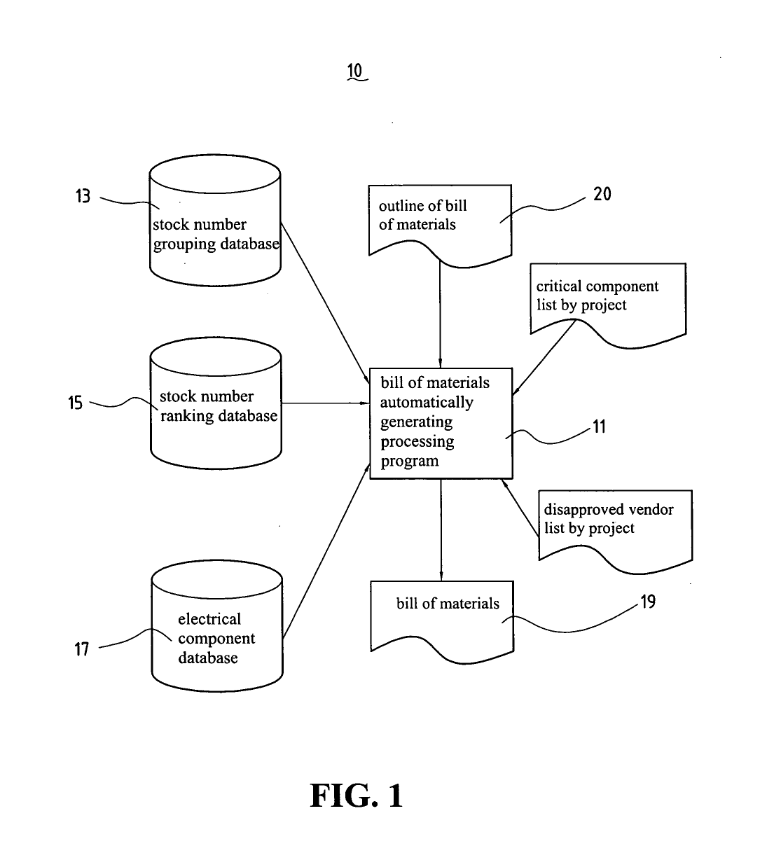

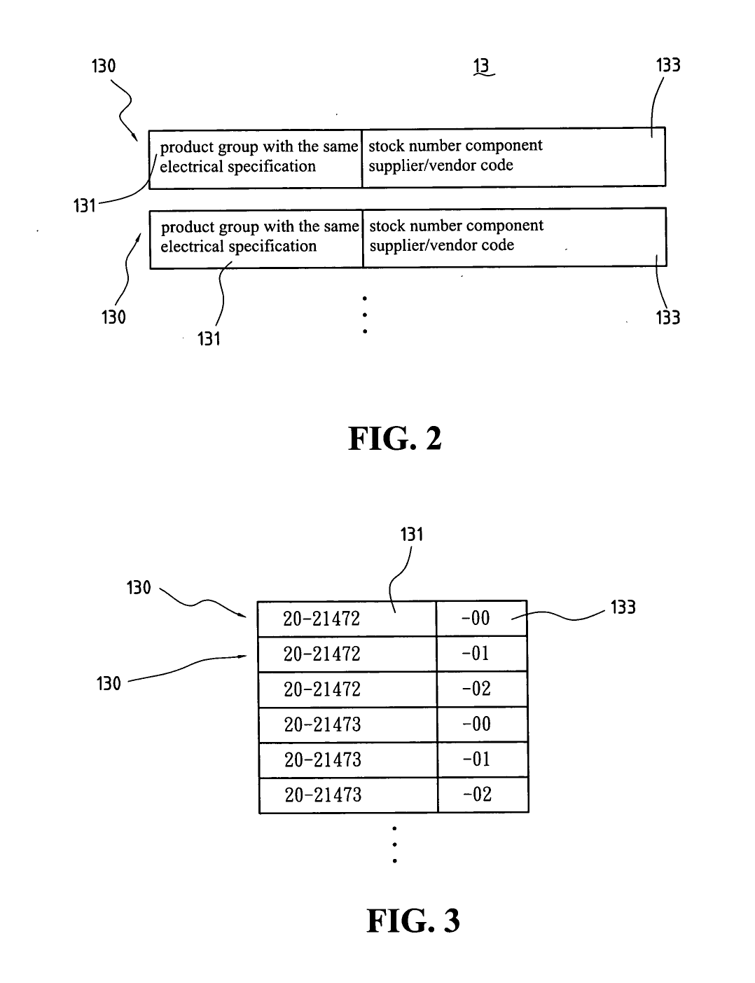

FIG. 1 shows a scheme diagram of the generating system of automatically generating a bill of materials of electrical products of the present invention. The generating system 10 main comprises a stock number grouping database 13, a stock number ranking database 15, an electrical component database 17, and a bill of materials automatically generating processing program 11, as described as below herein. Please refer to FIG. 2 which shows a structure diagram of the stock number grouping database of the present invention. The stock number grouping database 13 mainly comprises at least one stock number group record 130, and each stock number group record 130 comprises at least the product groups with the same electrical specification 131 and at least one stock number group component supplier/vendor codes 133. Further coordinating with FIG. 3, a concrete example diagram of the stock number grouping database of the present invention. In FIG. 3, the product group with the same electrical specification 131 uses seven digit codes to record and distinguish each electrical specification product, such as “20-21472” and “20-21473” respectively representing different electrical specification products. In FIG. 3, the stock number component supplier/vendor code 133 uses a three digit code to record and distinguish the difference belonging to this electrical specification product, such as “-00” represents all electrical component suppliers of this electrical specification product. On the other hand, “20-21472-00”, an instance of the stock number group record 130 also represents the electrical specification of “20-21472”. For example, “-01” represents A supplier. On the other hand, “20-21472-01”, an instance of the stock number group record 130 also represents A supplier supplying the electrical specification of “20-21472”; and “20-21473-01”, an instance of the stock number group record 130 also represents A supplier supplying the electrical specification of “20-21473”. For example, “-02” represents B supplier. On the other hand, “20-21472-02”, an instance of the stock number group record 130 also represents B supplier supplying the electrical specification of “20-21472”.

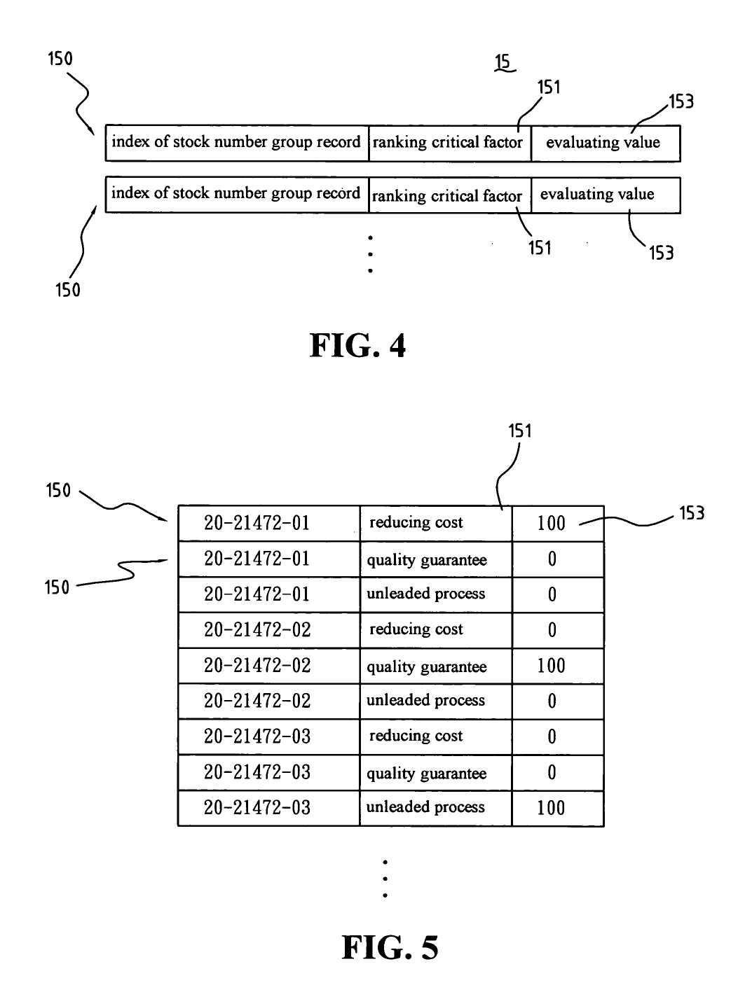

FIG. 4 shows a structure diagram of the stock number ranking database of the present invention. The stock number ranking database 15 comprises at least one stock number ranking record 150, and each stock number ranking record 150 corresponds to one of the stock number group records 130 and is used to record an evaluating value 153 after evaluating the stock number group records 130 according to each ranking critical factor 151. Please further coordinate with FIG. 5, which shows a concrete illustrated diagram of the stock number ranking database of the present invention. In FIG. 5, a concrete means of the ranking critical factor 151, for example, can use “reducing cost”, “quality guarantee”, “unleaded process”. The stock number record 130 of “20-21472-01” shown in FIG. 5 has evaluating values 153 of 100 points, 75 points, 50 points, and 25 points for each ranking critical factor 151. Continuing to the above mentioned descriptions, the purchasing price of the electrical components of the electrical specification “20-21472” supplied by A supplier can meet the requirements; however, the factors of quality guarantee and unleaded process can't.

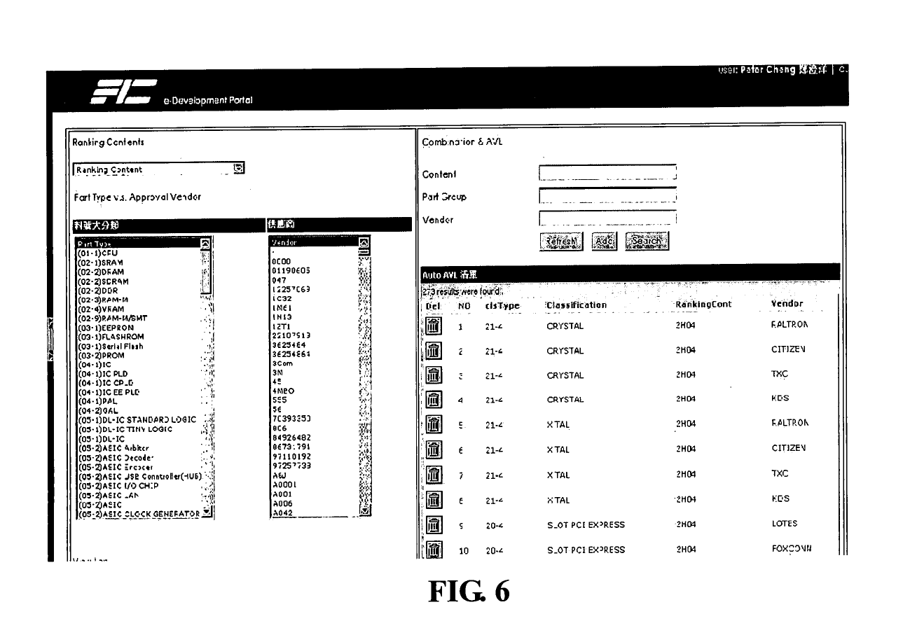

FIG. 6 shows a screen of the stock number ranking database performing maintenance of the present invention. Each stock number group record 130 of the stock ranking database 150 of the present invention can be changed according to the strategies. On the screen in FIG. 6, is described the maintenance of each stock number ranking record 150 related to the electrical component products of a computer motherboard.

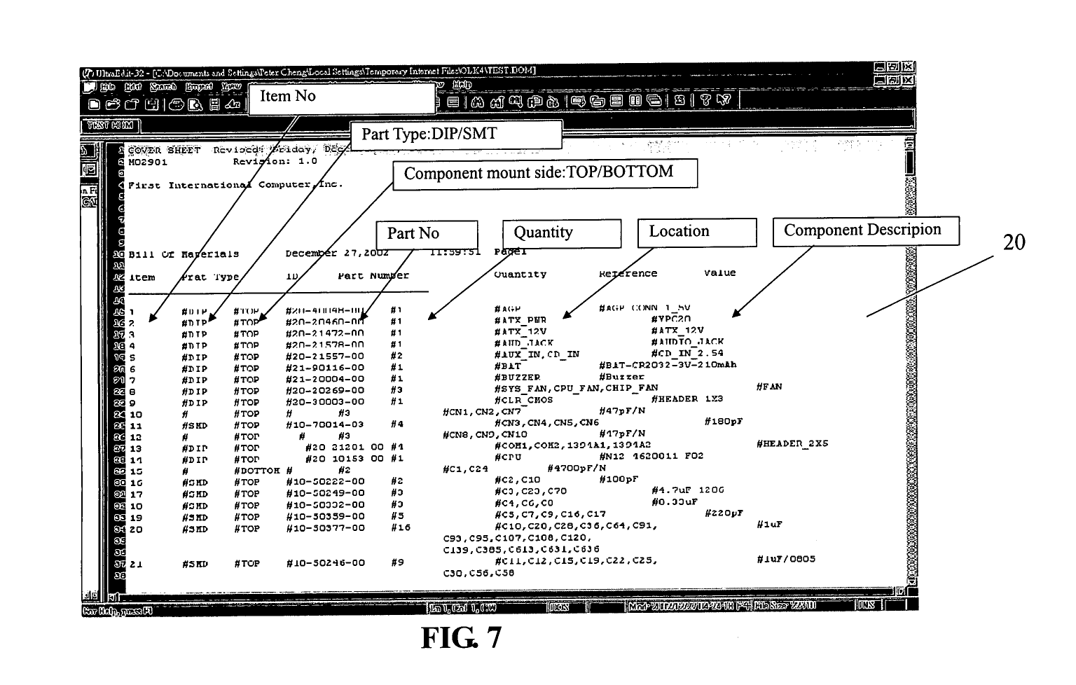

Generally, designers of the electrical products can directly execute existing commercial applications, for example, computer aided design, to produce the design diagram of an electrical circuit. When the designers choose electrical components to design the electrical circuit, choosing materials can be made through accessing the electrical component database 17. The number of each material of the electrical component database 17 respectively corresponds to one of the product groups of the same electrical specification 131 of the stock number grouping database 13, i.e. the number of each material of the electrical component database 17 relates to one of the stock number group records 130. Please refer to FIG. 7, showing an illustrated screen of an outline of the bill of materials 20 of the electrical products of the computer motherboard.

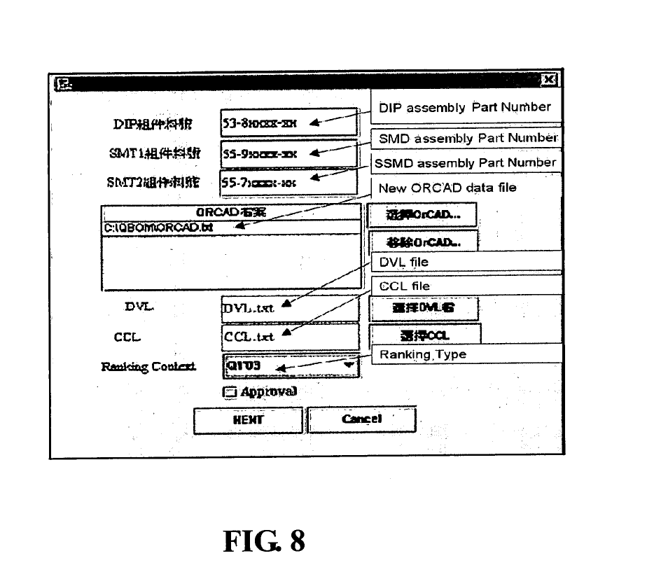

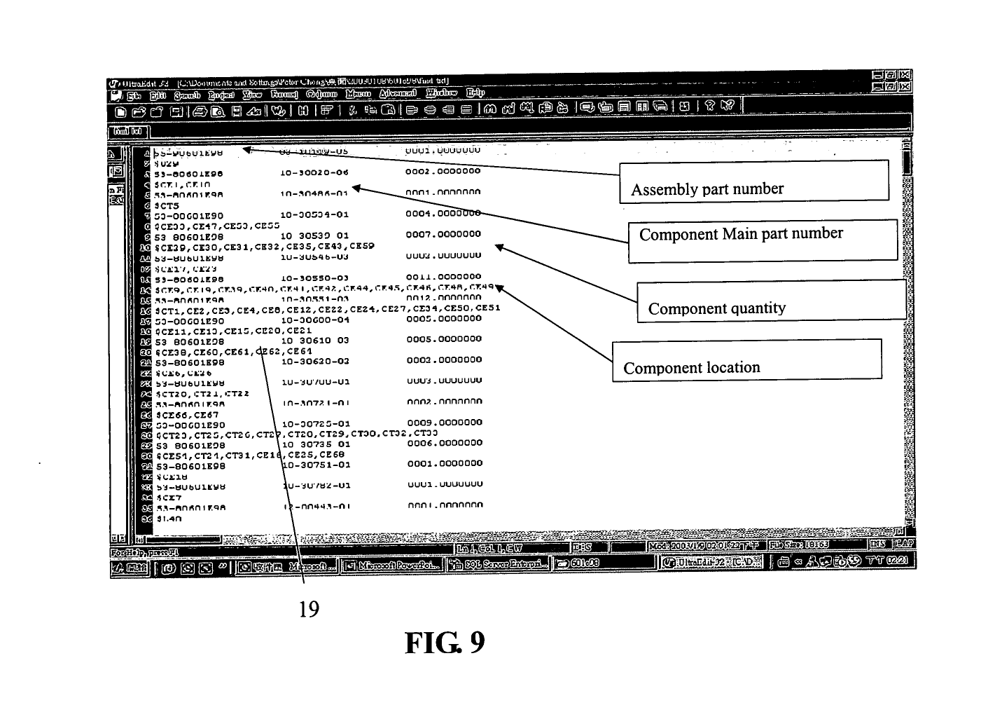

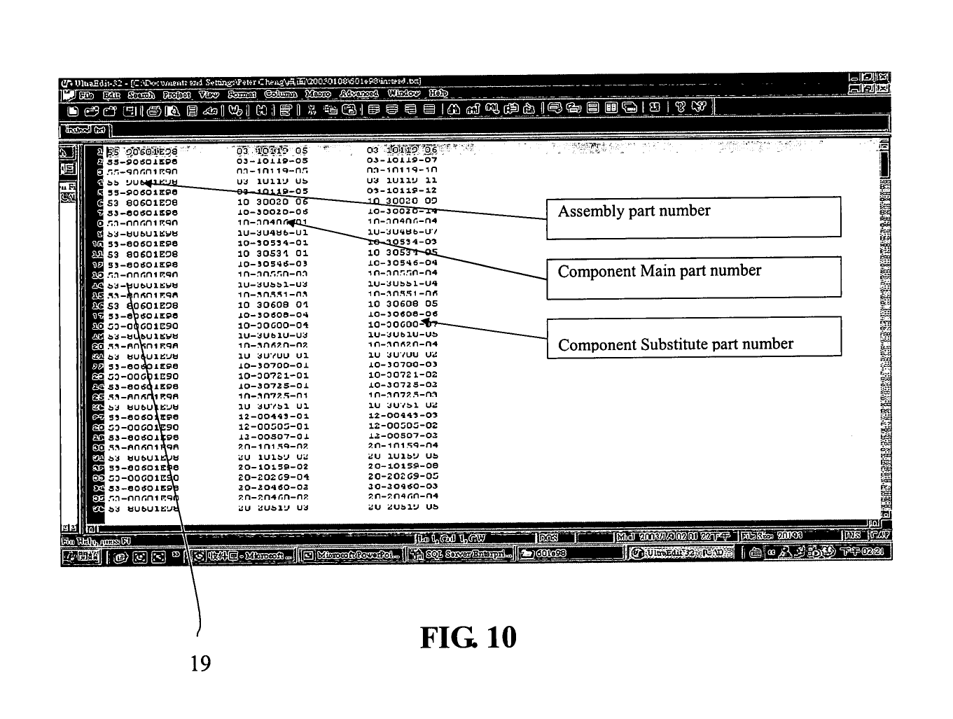

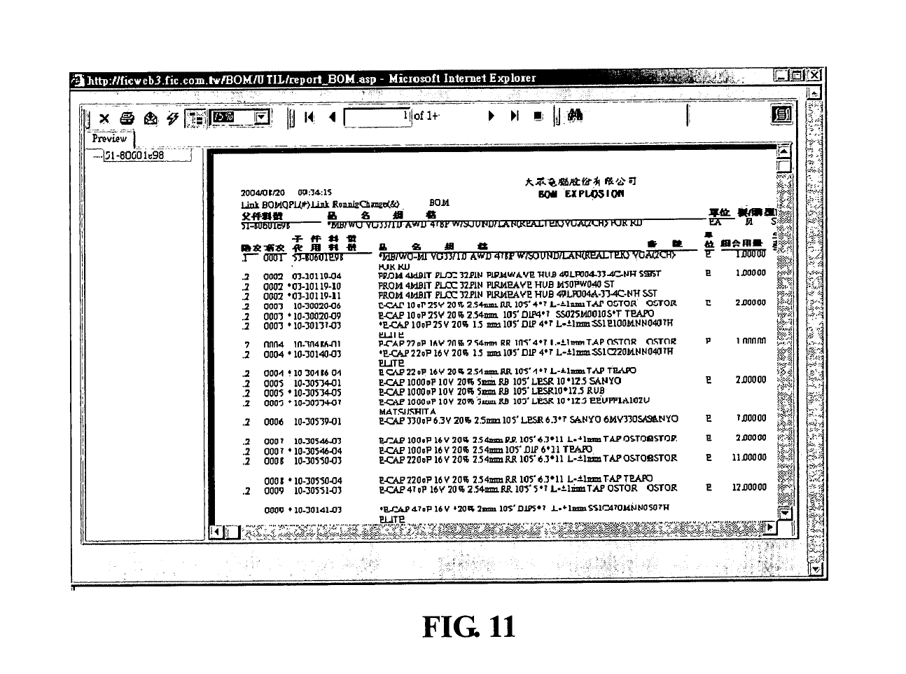

The main function of the bill of materials automatically generating processing program 11 of the present invention is producing a corresponding bill of materials 19 according to the input electrical circuit design diagram which corresponds to the belonged outline of the bill of materials 20, stock number grouping database 13, stock number ranking database 15, material choosing critical factor, etc. The concrete means of the material choosing critical factor can use an individual ranking critical factor 151 or use a combination of individual ranking critical factors 151. FIG. 8 shows a main screen of the bill of materials automatically generating processing program of the present invention, and please coordinate referring to FIG. 9, showing a screen of bill of materials automatically generated by executing the bill of materials automatically generating the processing program of the present invention which outputs the bill of materials of main materials, FIG. 10, showing a screen of bill of materials automatically generated by executing the bill of materials automatically generating processing program of the present invention which outputs the bill of materials of substituted materials, and FIG. 11, showing a screen of bill of materials automatically generated by executing the bill of materials automatically generating processing program of the present invention which outputs the bill of materials of main materials and substituted materials at once. After deciding the desired material choosing critical factor, i.e. deciding a ranking way, the material choosing critical factor will search the stock number grouping database 13 and the stock number ranking database 15 according to all electrical components of the electrical circuit design diagram, statistics the ranks according to the evaluating value 153 of each electrical components obtained after searching, and finally outputs the best bill of materials 19 according to the material choosing critical factor.

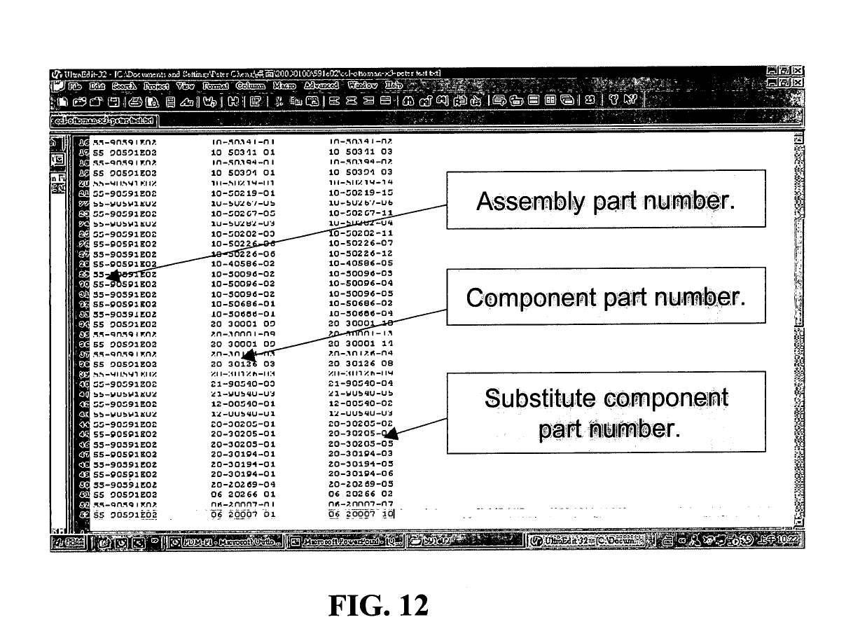

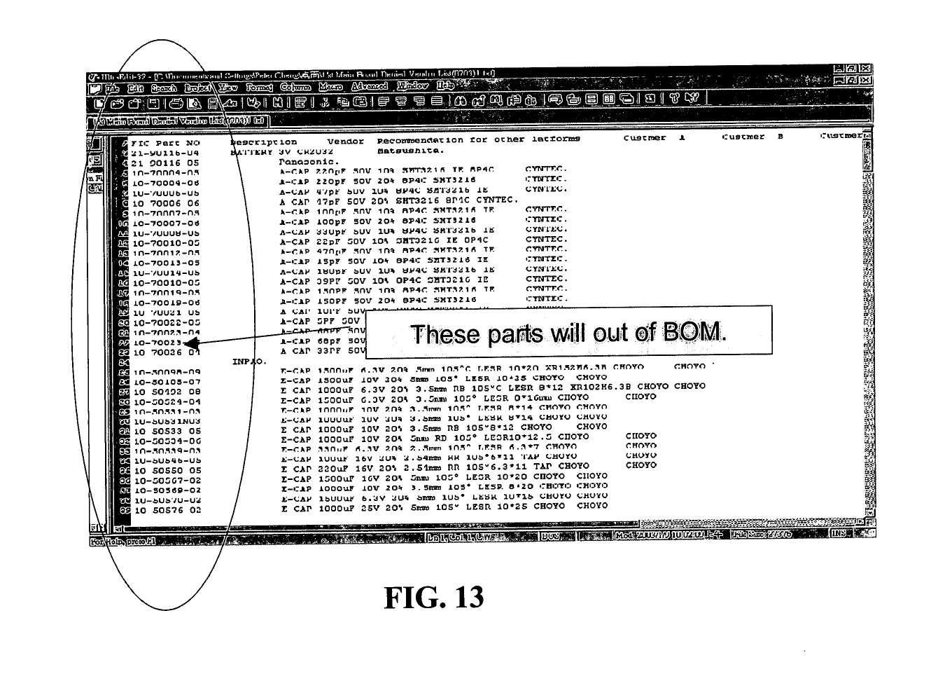

Further, the material choosing critical factor of the present invention can give a special specified condition such that the bill of materials 19 produced by the bill of materials automatically generating processing program 11 can totally meet the special specified condition. The material choosing critical factor under the special specified condition is, for example, a limited condition of components specified for some project, please coordinate referring to FIG. 12. In the components listed in the critical component list by project (CCL) shown in FIG. 12, the automatically generating processing program 11 produces a bill of materials 19 corresponding with this project. The content of the bill of materials 19 will show these components all chosen. Taking another example, the material choosing critical factor under the special specified condition is a limited condition of preventing some projects from using the components of some specified vendors, please coordinate referring to FIG. 13. In the components listed in the disapproved vendor list by project (DVL) in FIG. 13, the automatically generating processing program 11 produces a bill of materials 19 corresponding with this project. The bill of materials 19 did not choose these components at all.

The advantages quipped by the generating system of automatically generating the bill of materials of electrical products of the present invention are as follows:

1. greatly reducing the lapse rate of artificial adjusting materials.

2. greatly reducing the produced time of the bill of materials.

3. choosing different suppliers in the bill of materials according to different strategies to supply electrical components.

4. choosing different suppliers in the bill of materials according to different electrical product project requirements to supply electrical components.

5. choosing or filtering electrical components supplied by specified component vendors according to the clients' project requirements such that the components can directly exist or un-exist in a generated bill of materials.

6. building standardized stock number grouping database, stock number ranking database, and electrical component database to facilitate each design department to reduce building time of data and let all designed data and each design department have the same database.

Through the descriptions of the above preferred embodiments, the features and spirits of the present invention are further described clearly. However, the present invention did not add limitation to the scope of the present invention with the above disclosed preferred embodiments, and more importantly, the present invention covers each alternation and equivalent arrangement in the scope of claimed claims of the present invention.

What is claimed is:

1. A generating system for automatically generating a bill of materials of electrical products comprising:
a stock number grouping database comprising at least one stock number group record, wherein every stock number group record comprises at least a product group with the same electrical specification and at least a material group component supplier/vendor codes;
a stock number ranking database comprising at least one stock number ranking record, wherein each stock number ranking record corresponds to one of the stock number ranking records and is used to record an evaluating value after evaluating with the stock number group record according to a ranking critical factor;
a bill of materials automatically generating a processing program used to generate a bill of materials corresponding to the bill of materials of a design diagram of an electrical circuit according to the input design diagram of electrical circuit, said stock number grouping database, said stock number ranking database, a material choosing critical factor.

2. The generating system as claimed in claim 1, wherein said generating system further comprises: an electrical component database used to record at least the electrical specification of each electrical component, wherein the electrical specification of each electrical component respectively corresponds to said product group with the same electrical specification of one of said stock number group records.

3. The generating system as claimed in claim 1, wherein said stock number group component supplier/vendor codes are used to respectively represent all electrical component suppliers of the electrical components defined by the product group supplying the same electrical specification according to a value of the codes.

4. The generating system as claimed in claim 1, wherein said ranking critical factor is selected from a reducing cost, a quality guarantee, and an unleaded process.
